(19) United States
(12) Patent Application Publication
(10) Pub. No.: US 2010/0260113 A1
(43) Pub. Date: Oct. 14, 2010

(54) ADAPTIVE RESOURCE ALLOCATION PROTOCOL FOR NEWLY JOINING RELAY STATIONS IN RELAY ENHANCED CELLULAR SYSTEMS

(75) Inventors: Yong Liu, Santa Clara, CA (US); Chiu Ngo, San Francisco, CA (US)

Correspondence Address: Myers Andras Sherman LLP, 19900 MacArthur Blvd., Suite 1150, Irvine, CA, 92612, US

(73) Assignee: Samsung Electronics Co., Ltd., Suwon City (KR)

(21) Appl. No.: 12/422,107

(22) Filed: Apr. 10, 2009

(51) Int. Cl. H04W 72/00; H04B 7/14

(52) U.S. Cl. 370/329; 455/452.2; 455/7

(57) ABSTRACT

A method and system for allocating subcarrier frequency resources in a relay enhanced cellular communication system including a base station, multiple relay stations and mobile stations. One implementation involves, for a new relay station joining the relay enhanced cellular communication system, identifying mobile stations that the new relay station can service, and assigning sufficient resources to the new relay station to accommodate minimum data rate requirements of the access links of the identified mobile station. The resources are assigned by adjusting existing resource assignments essentially in an optimal manner while reducing impact on existing stations in the relay enhanced cellular communication system.

### FIELD OF THE INVENTION

The present invention relates to wireless cellular communication and in particular to relay enhanced cellular communication systems.

### BACKGROUND OF THE INVENTION

A typical cellular communication system includes one or more base stations and multiple mobile stations, as shown in FIG. 1A. Each base station (BS) defines a cell of coverage, where each mobile station (MS) can communicate with a BS via a BS→MS link while within communication range of the BS cell coverage. In many cellular systems, radio resource management (RRM) for orthogonal frequency division multiple access (OFDMA)-based cellular systems is utilized. Such systems address resource allocations (e.g., frequency, time, power), among BS→MS links (i.e., transmission channels defined by frequency subcarriers, spreading codes or time slots).

There are two types of RRMs: intra-cell RRM and inter-cell RRM. The intra-cell RRM attempts to assign resources to MSs or BS→MS links within a cell (and prevent interference among MSs). The inter-cell RRM attempts to assign resources to multiple cells (and prevent interference among BSs and MSs in different cells). Available frequency bandwidth is divided into frequency subcarriers and assigned to the BS→MS links based on channel conditions and traffic demands. End-to-end throughput between a BS and MS is a function of Signal-to-Interference-and Noise-Ratio (SINR) of the link between the BS and MS. An access link is a communication link between a mobile station and a relation station, or between a mobile station and the base station. A relay link is a communication link between a relay station and the base station.

Intermediate relay stations (RS) have been used for improving throughput, coverage, and spectrum efficiency of cellular systems. FIG. 1B shows an example cellular system including a base station BS and multiple MSs and relay stations (RS1, . . . , RS6). A two-hop transmission takes place between a BS and MS via a RS, wherein a RS may be an MS itself. The introduction of relay stations brings forth new challenges to the RRM design. RRM for relay enhanced cellular (REC) systems has to address resource allocations among BS→MS, BS→RS, and RS→MS communication links.

In order to support relay stations, communication time frames can be divided into access zones and relay zones. In access zones, relay stations communicate with two-hop mobile stations. In relay zones, relay stations communicate with the BS. The BS can communicate with direct mobile stations (or one-hop mobile stations) in both access zones and relay zones. Note that access zones and relay zones are defined in time domain.

In a REC system, there are two types of cells: BS cells and relay cells. The BS cell is usually adjacent to every relay cell; therefore, it cannot share the same frequency resource with the relay cells. Nevertheless, relay cells that are well separated from each other may reuse resources such as subcarrier frequencies in their access links. However, resource reuse introduces new challenges to subcarrier allocation. One conventional subcarrier allocation approach proposes an equal power multi-cell resource allocation process, wherein subcarriers are assigned one-by-one to one or more cells. For each subcarrier, all cells are examined, starting from the most under-assigned one and ending to the most over-assigned one. In each cell, every MS is evaluated on its contribution/harm to the overall throughput. If none of the MSs in a cell can improve the overall throughput, the cell is skipped. If one or more MSs in a cell can improve the overall throughput, an MS that provides the most benefit to the throughput is assigned the subcarrier. Another conventional subcarrier allocation approach proposes a multi-cell resource allocation process which takes into account minimum data rate constraints. For each subcarrier, all under-assigned MSs are evaluated, starting from the MS that provides the most benefit to the overall throughput. MSs are added to share the subcarrier until no more MSs can benefit the overall throughput. Once an MS achieves its desired data rate, it shall not accept more subcarriers. This constraint is removed when all MSs meet their data rate requirements. Such conventional multi-cell resource allocation approaches handle all cells in the same way.

Existing resource allocation approaches assume that RSs are deployed at the initial cell planning stage. Resource allocation is conducted from the beginning after all RSs are geographically positioned. All resources are available to a resource controller at the beginning of the resource allocation process, and the resource controller assigns resource units to the stations that can benefit most from the resources.

### BRIEF SUMMARY OF THE INVENTION

The present invention provides a method and system for allocating subcarrier frequency resources in a relay enhanced cellular communication system including a base station, multiple relay stations and mobile stations. One embodiment involves, for a new relay station joining the relay enhanced cellular communication system, identifying mobile stations that the new relay station can service, and assigning sufficient resources to the new relay station to accommodate minimum data rate requirements of the access links of the identified mobile stations. Said resources are assigned by adjusting existing resource assignments essentially in an optimal manner while reducing impact on existing stations in the relay enhanced cellular communication system.

Identifying mobile station that the new relay station can service may further comprise determining local communication channel conditions for the new relay station, and based on the local channel conditions of the new relay station, identifying a mobile station that may be serviced by the new relay station to accommodate minimum data rate requirements of the access links of the identified mobile station.

Identifying a mobile station that may be serviced by the new relay station may further comprise dividing the mobile stations near the new relay station into multiple types including a first type: a mobile station outside the coverage of the base station and other relay stations; a second type: mobile station directly served by the base station; and a third type: a mobile station served by adjacent relay stations. Assigning sufficient resources to the new relay station may further comprise considering if the new relay station can more efficiently utilize resources previously assigned to second and third type mobile stations, and if so, then adjusting resource assignments such that the resources previously assigned to the second and third type mobile stations are reallocated to the new relay station.

Assigning sufficient resources to the new relay station may further comprise detecting resources essentially immediately available to the new relay station, classifying the detected resources into multiple categories based on quality of said resources including: a clean resource comprising: a residual resource not yet allocated, a resource used by the base station to support second type mobile stations not reusable by other relay stations, and a resource exclusively used by adjacent relay stations to support third type mobile stations not reused by other relay stations; a reusable resource comprising: a resource used by a remote relay station and reusable by the new relay station; and a dirty resource comprising: a resource used by an adjacent relay station to support third type mobile stations while the resource is also reused by another adjacent relay station to support non-third type mobile stations, thus is not reusable by the new relay station.

Adjusting existing resource assignments essentially in an optimal manner may comprise adjusting existing resource assignments based on said resource categories, to provide sufficient resources to the new relay cell to meet minimum data rate requirements of access links of the identified mobile stations while maintaining the resource supplies to other relay cells.

Adjusting existing resource assignments may further comprise adjusting resources starting from clean resources, by assigning clean resources first to second and third type mobile stations to meet their minimum data rate requirements; and assigning remaining clean resources to first type mobile stations to meet their minimum data rate requirements.

Adjusting existing resource assignments may further comprise, if clean resources are not sufficient to meet the minimum data rate requirements of the second and third type mobile stations, then reallocating reusable resources that were originally assigned to third type mobile stations to second and third type mobile stations in the new relay cell; and allocating reusable resources to the new relay cell if reuse improves the overall system throughput.

If the reallocation of the reusable resources impairs the throughput of remote relay cells sharing the same resources, clean resources assigned exclusively to second and third type mobile are reused in these relay cells impacted by the resource reallocation, wherein clean resources are reused in the relay cells only if the reuse can improve the overall system throughput.

Adjusting existing resource assignments may further comprise, if the reusable resources, together with the clean resources, are still not sufficient to meet the minimum data rate requirements of the second and third type mobile stations, then detecting additional reusable resources from remote relay cells, starting from a remote relay cell that generates the least co-channel interference with the new relay cell; and assigning the additional reusable resources to second and third type mobile stations for the new relay cell until all such mobile stations meet their minimum data rate requirements.

These and other features, aspects and advantages of the present invention will become understood with reference to the following description, appended claims and accompanying figures.

### BRIEF DESCRIPTION OF THE DRAWINGS

FIG. 1A shows a typical cellular communication system.

FIG. 1B shows a typical relay enhanced cellular communication system.

FIGS. 2A-B show example resource maps for a relay enhanced cellular communication system implementing adaptive resource allocation involving for newly joining relay stations, according to an embodiment of the invention.

FIG. 3 shows a flowchart of a process for adaptive resource allocation involving for newly joining relay stations in a relay enhanced cellular system, according to an embodiment of the invention.

FIG. 4A shows an example relay enhanced cellular communication system with a newly joining relay cell, implementing adaptive resource allocation involving for newly joining relay stations, according to an embodiment of the invention.

FIG. 4B shows an example resource map and communication time frame for a relay enhanced cellular communication system implementing adaptive resource allocation involving for newly joining relay stations, according to an embodiment of the invention.

FIGS. 5A-B show example resource maps and communication time frames for a relay enhanced cellular communication system implementing adaptive resource allocation involving for newly joining relay stations, according to an embodiment of the invention.

FIG. 6 shows a more detailed flowchart of a process for adaptive resource allocation involving for newly joining relay stations in a relay enhanced cellular system, according to an embodiment of the invention.

FIG. 7 shows a functional block diagram of a resource allocation controller configured for adaptive resource allocation involving for newly joining relay stations in a relay enhanced cellular system, according to an embodiment of the invention.

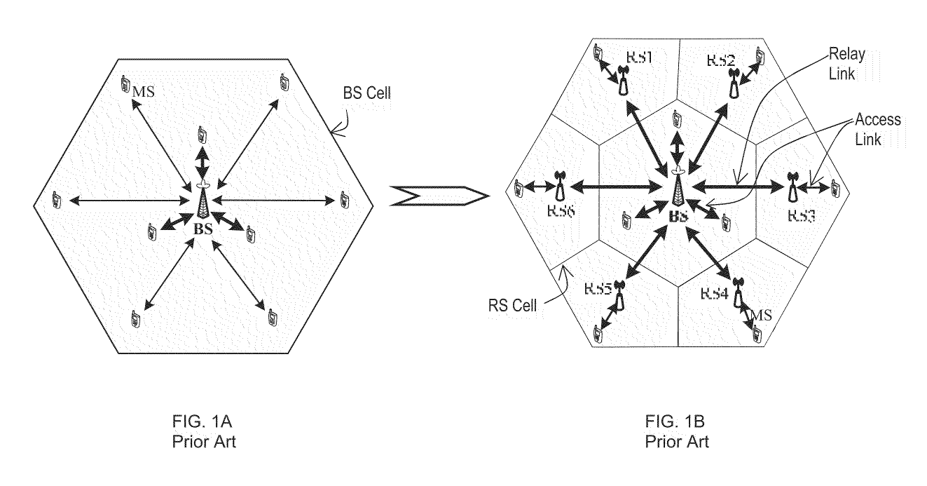

### DETAILED DESCRIPTION OF THE INVENTION

The present invention provides a method and system for adaptive resource allocation for newly joining relay stations (RSs) in a relay enhanced cellular system (REC). The resources are assigned essentially in an optimal manner.

In a REC system, RSs are deployed to improve wireless (e.g., radio frequency) link quality and/or extend cell coverage. RSs may be added to the REC system at initial cell planning stage, or in an on-demand (ad-hoc) manner. When a new RS is added to an operating REC system on-demand, according to the invention, a resource controller responsible for subcarrier allocation assigns sufficient resources to the new RS to support MSs identified to be serviceable by the new RS. The MS station identification (selection) and resource assignment enable better utilization of the REC system resources, thus enhancing overall REC system capacity, and cause essentially minimum impact on the existing stations in the REC system (i.e., reduce impact of resource allocation in order to accommodate new relay stations since large scale resource reallocation may affect ongoing data traffic). Said resources may include frequency, subcarrier frequency, time, power.

When a new RS attempts to join the REC system, certain resources have already been assigned to existing stations, wherein a resource controller according to the invention attempts to adjust the resource assignment (e.g., subcarrier frequency resource allocation) in order to fulfill the requirements of the newly joining RS. The resource adjustment is adaptive to minimize impact on existing stations while assigning sufficient resources to the new RS. The resource controller implements a protocol for collecting, classifying, and allocating available resources to newly joining RSs. The resource allocation protocol enables new joining RSs to make better use of available resources, and provide better support to their local mobile stations. The protocol tightly controls the scope of resource adjustment, and minimizes impact on existing relay cells and mobile stations.

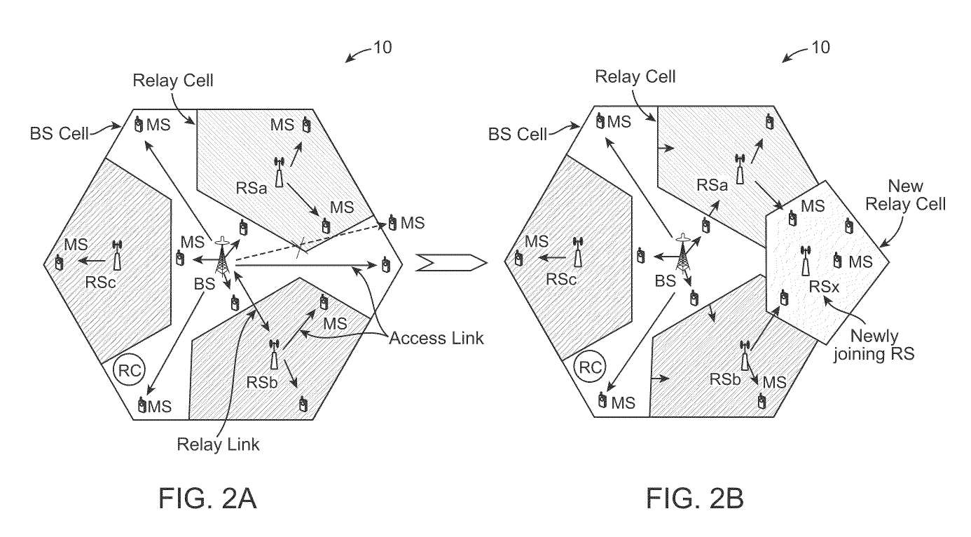

In one implementation, a resource controller according to the invention implements an adaptive resource allocation protocol for resource allocation/adjustment for joining a new RS into an already up-and-running REC system 10 shown in FIG. 2A. The REC system 10 includes a base station BS, existing relay stations RSa, RSb, RSc, and multiple mobile stations MS. In FIG. 2A, the dashed arrow with superimposed “x” indicates the corresponding MS is out of the coverage range of the BS and other relay stations, but may be covered by a newly joining relation station as shown by example in FIG. 2B. When new relay station (RSx) attempts to join the REC system 10, it is assumed that most available resources have been allocated to the existing stations in the REC system to support on-going data traffic. Therefore, in order to accommodate the newly joining RS, the resource controller RC adjusts the existing resource assignment to provide sufficient resource support to the new joining RS.

As such, instead of reallocating all resources from the beginning (which is time-consuming and may significantly impact the on-going traffic), the resource controller implements an adaptive resource allocation protocol for adjusting only the resources that can be better utilized by the new RS, and have minimum impact on existing stations. The resource controller identifies and classifies such resources. The resource controller further allocates such resources optimally to new RSs. The resource controller enables simple, prompt, and adaptive resource allocations to newly added relay stations, without engendering significant impacts on existing relay cells and on-going data communication traffic in the base cell and the relay cells of the REC system.

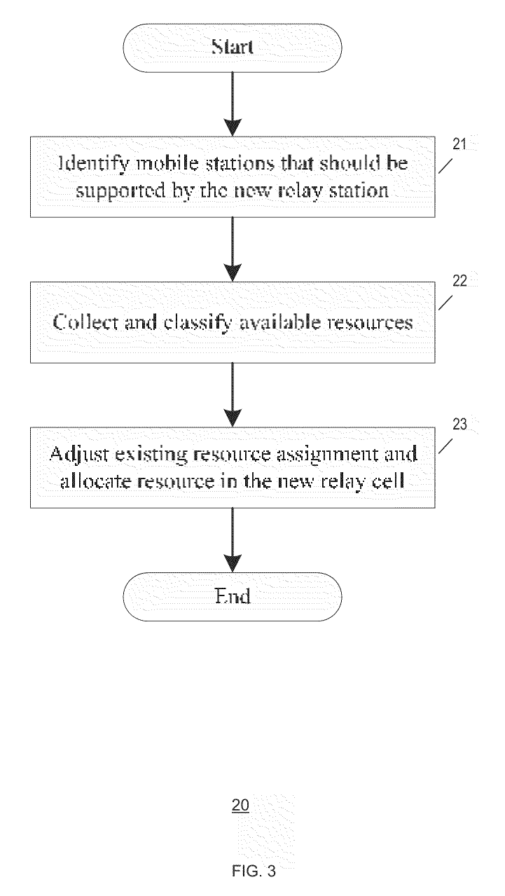

The resource controller performs three main operations as shown by process 20 in FIG. 3:
Block 21: Determining local communication channel conditions for the newly joining relay station. Based on the local channel conditions of the newly joining relay station (new relay station), identifying the mobile stations that may be serviced (supported) by the new relay station to meet minimum communication data rate requirements of each mobile station.
Block 22: Detecting (collecting) resources essentially immediately available to the new relay station, and classifying the immediately available resources into multiple categories based on quality of said resources (i.e., clean resources, reusable resources and dirty resources, described further below).
Block 23: Adjusting existing resource assignments based on said resource categories to provide sufficient resources to the new relay cell to meet minimum data rate requirements of access links of the identified mobile stations, while maintaining the resource supplies to other relay cells by reducing, and preferably minimizing impact on existing stations (i.e., without engendering significant impact on existing relay cells and on-going traffic).

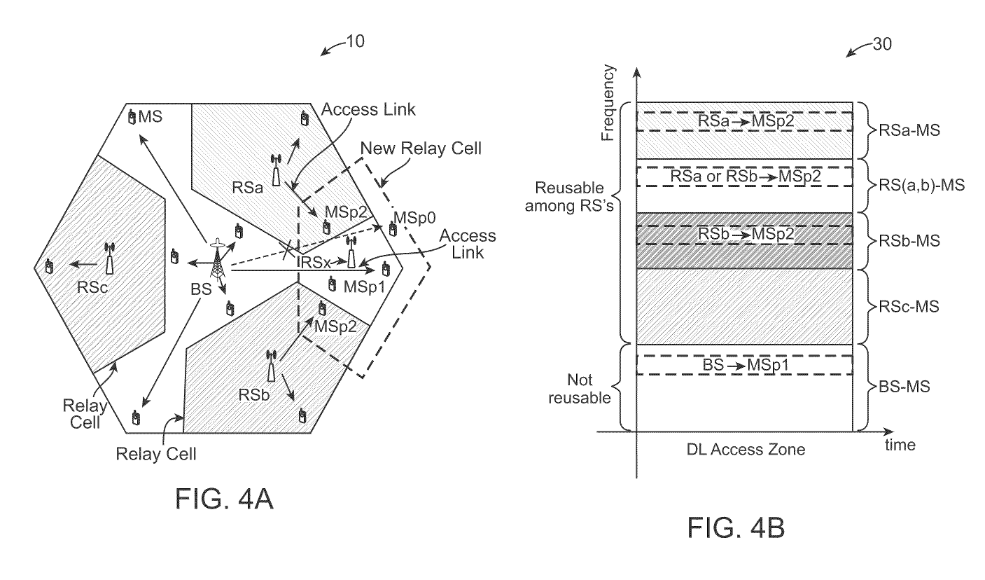

Implementation details of each of the three process blocks 21-23 are described below. For process block 21, as shown in FIG. 4A, in the REC system 10 the mobile stations MS near the newly joining relay station RSx may be divided into multiple types, as described below:
Type 1: Mobile stations such as MSp0 that are outside the coverage of the BS and other relay stations RSa, RSb, RSc.
Type 2: Mobile stations such as MSp1 that are served by the BS.
Type 3: Mobile stations such as MSp2 that are served by adjacent relay stations RSa and RSb. Type 3 mobile stations are served by relay stations that are adjacent to the newly joining relay station.

The resource controller does not assign any resource to Type 1 mobile stations such as MSp0. The resource controller assigns resources to access links (BS→MS links and RS→MS links) for Type 2 and Type 3 mobile stations such as MSp1 and MSp2, to fulfill their minimum data rate requirements, but the resources are utilized poorly. FIG. 4B shows an example frequency resource assignment 30 for MSp1 and MSp2 mobile stations, shown as frequency versus down link (DL) access zone, according the invention. Resources assigned to BS→MS links cannot be reused, while resources assigned to RS→MS links may be reused in different relay cells. Since the BS cell is physically close to all relay cells, the resources assigned to the BS cell (i.e., BS-MS links, including the resources assigned to BS→MSp1 links) cannot be reused in any relay cell. The resources assigned to one relay cell (i.e., RS-MS links) may be reusable in another relay cell if these two relay cells are well separated. In the example shown in FIG. 4B, some resources assigned to RSa-MS links are reused in the RSb cell (for some RSb-MS links), while some other resources assigned to RSa (RSb) cell are not reused in the RSb (RSa) cell. It is also possible that the resources shared by RSa and RSb cells are assigned to some of the MSp2 devices (respectively in each of these two cells).

If the new relay station RSx can make better use of the resources that have been assigned to Type 2 and Type 3 mobile stations (e.g., MSp1 and MSp2, respectively) to better service the Type 2 and Type 3 mobile stations (e.g., meet minimum data rate requirements of MSp1 and MSp2 mobile stations while increasing system throughput), then the resource controller adjusts resource assignments such that RSx may take over servicing mobile stations Type 2 and Type 3 mobile stations (e.g., MSp1 and MSp2, respectively) and the resources previously assigned to Type 2 and Type 3 mobile stations (e.g., MSp1 and MSp2, respectively) are reallocated to the new relay station RSx. With the same resources, the new relay station RSx may either enhance the data rates of Type 2 and Type 3 mobile stations (e.g., MSp1 and MSp2, respectively), or accommodate some of the Type 1 mobile stations such as MSp0. The new relay station can utilize the resources to provide better data rates to MSp1 and MSp2 devices, or the new relay station can use part of the resources to meet the data rate requirements of MSp1 and MSp2 devices, and use the remaining resources to serve MSp0 devices. By either means, the new relay station makes better use of the resources and increases the overall system throughput.

To determine whether the new relay station RSx can more efficiently use (i.e., can make better use of) the resources that have been assigned to Type 2 and Type 3 mobile stations (e.g., MSp1 and MSp2, respectively), the resource controller may request the new relay station RSx to transmit sounding signals to its local mobile stations (i.e., mobile stations within the RSx relay cell). Such local mobile stations, upon receiving the sounding signals, report the channel qualities of their access links to RSx (i.e., the communication links between RSx and its local mobile stations). Then RSx collects the channel quality information of all such access links and forwards that information to the resource controller. In addition, RSx and the existing relay stations RSa, RSb, RSc, measure co-channel interference (i.e., crosstalk from two different radio transmitters using the same frequency) to each other and report that information to the resource controller.

Once the resource controller receives all the access link channel quality information and co-channel interference information, the resource controller analyzes the resource utilizations of Type 2 and Type 3 mobile stations (e.g., MSp1 and MSp2, respectively). For each of the Type 2 and Type 3 mobile stations (e.g., MSp1 and MSp2, respectively), if RSx can achieve a better resource utilization on the associated access link than the current serving station of that mobile, then the resource controller marks the mobile station as a potential member of the RSx relay cell. The MSp0 stations with fairly good channel qualities on their access links to the RSx may also be marked as the potential members of the RSx relay cell.

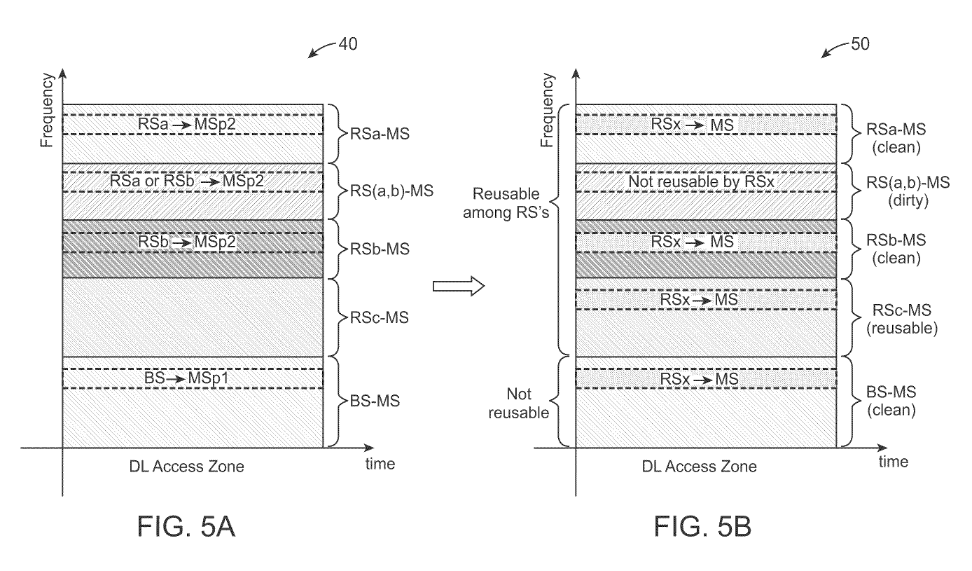

For process block 22 (FIG. 3), as shown by example assignment 40 in FIG. 5A, initially Type 2 and Type 3 mobile stations (e.g., MSp1 and MSp2, respectively) have been assigned resources on their access links (connecting to current serving stations), shown as frequency versus down link (DL) access zone. When Type 2 or Type 3 mobile stations (e.g., MSp1 or MSp2) are reallocated to the RSx relay cell, the resources originally assigned to them may be immediately reallocated (reassigned) to the new relay station RSx by the resource controller.

However, the reallocated resources may not be equally useful to the new relay station RSx. As shown by example assignment 50 in FIG. 5B, the resources originally assigned to Type 2 stations (e.g., MSp1 stations) cannot be reused by other relay cells (i.e., RSa, RSb, RSc). Therefore, the new relay station RSx may freely use such resources without concern about co-channel interferences to other relay cells (i.e., RSa, RSb, RSc). For a resource originally assigned to Type 3 stations (i.e., MSp2 stations), as the resource may be reused by multiple relay cells, the new relay station RSx may or may not be able to use the resource (depending on whether the new relay station RS is sufficiently close in distance to the co-channel relay cells). In addition to the resources originally assigned to Type 2 and Type 3 mobile stations (i.e., MSp1 and MSp2 stations), the new relay station RSx may also reuse the resources assigned to remote relay cells (such as relay cell of RSc), in order to accommodate more mobile stations.

The resources available to the new relay station RSx can be divided into one of three categories:
A clean resource including: A residual resource not yet allocated, a resource used by the base station to support Type 2 mobile stations (e.g., MSp1 stations) not reusable by other relay stations, and a resource exclusively used by adjacent relay stations (such as RSa and RSb) to support Type 3 mobile stations (e.g., MSp2 stations) not reused by other relay stations.
A reusable resource including: A resource used by remote relay stations (such as RSc) and reusable by the new relay station RSx.
A dirty resource including: A resource used by an adjacent relay station such as RSa, to support Type 3 mobile stations (e.g., MSp2 stations) but at the same time reused by another adjacent relay station (such as RSb) to support non-Type 3 mobile stations (thus not reusable by the new relay station RSx).

The resource controller identifies the mobiles stations that may be included in the RSx relay cell, collects all the resources originally assigned to the identified mobile stations, and classifies the resources as clean, reusable, and dirty resources. If needed, the resource controller may also collect reusable resources for the new relay station RSx from remote relay cells (such as RSc). In the examples shown in FIGS. 5A-B, the resources originally assigned to BS→MSp1, RSa→MSp2, RSb→MSp2 access links, are collected by the resource controller. Among them, the resources assigned to BS→MSp1 access links are clean resources. However, the resources assigned to RSa→MSp2 (or RSb→MSp2) links may be clean resources, dirty resources, or reusable resources, as follows:
If the resources assigned to RSa→MSp2 access links are not reused in any other relay cells, the resources are clean.
If the resources assigned to RSa→MSp2 access links are being reused by RSb, which is physically very close to the new relay cell RSx, then these resources may not be usable by the new relay station RSx due to heavy interference from RSb. Therefore, these resources are categorized as dirty resources.
If the resources assigned to RSa→MSp2 access links are being reused by a relay station (not shown) distant from the RSx relay cell, the resources may be usable by the new relay station. These resources are categorized reusable resources.

In addition, the resource controller may collect the resources being used by a remote relay station RSc, and make them reusable by the new relay station.

For process block 23 (FIG. 3), the resource controller performs resource adjustment starting from the clean resources in the new relay cell (i.e., RSx relay cell) so as to not impact stations outside the RSx relay cell. Clean resources are assigned first to the Type 2 and Type 3 mobile stations (e.g., MSp1 and MSp2 stations) to meet their minimum data rate requirements. Any remaining clean resources are assigned to Type 1 mobile stations (e.g., MSp0 stations) to meet their minimum data rate requirements. Accordingly, each resource unit is assigned to a mobile station that can make the best use of the resource.

If the clean resources are not sufficient to meet the minimum data rate requirements of the Type 2 and Type 3 mobile stations (e.g., MSp1 and MSp2 stations), then reusable resources that were originally assigned to Type 3 mobile stations (e.g., MSp2 stations) are reallocated to Type 2 and Type 3 mobile stations (e.g., MSp1 and MSp2 stations) in the RSx relay cell. Resources are reusable by the new relay station RSx (and reallocated accordingly) if reuse can improve the overall REC system throughput. However, utilizing reusable resources in the RSx relay cell may cause interference with co-channel relay cells. In order to compensate the relay cells that are impacted by resource reuse, the clean resources that have been assigned exclusively to the Type 2 and Type 3 mobile stations (e.g., MSp1 and MSp2 stations) are reused in such relay cells impacted by resource reuse. The clean resources are reused in the relay cells only if the reuse can improve the overall REC system throughput.

If the reusable resources, together with the clean resources, are still not sufficient to meet the minimum data rate requirements of the Type 2 and Type 3 mobile stations (e.g., MSp1 and MSp2 stations), then the resource controller detects additional reusable resources from remote relay cells, starting from a remote relay cell that generates the least co-channel interference with the new relay cell RSx. The additional reusable resources are assigned to Type 2 and Type 3 mobile stations (e.g., MSp1 and MSp2 stations) in the new relay cell RSx until all such mobile stations meet their minimum data rate requirements.

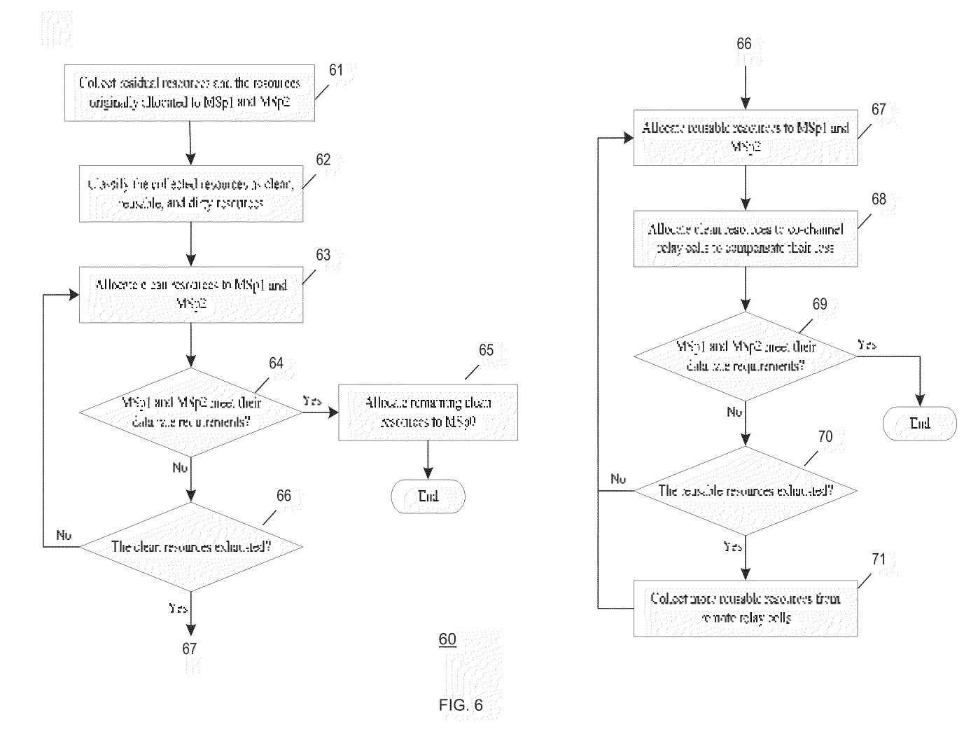

FIG. 6 shows a more detailed flowchart of a process 60 for adaptive resource allocation involving for a newly joining relay station in a relay enhanced cellular system, according to an embodiment of the invention:
Block 61: Detecting (collecting) residual resources and the resources originally allocated to Type 2 and Type 3 mobile stations (e.g., MSp1 and MSp2 stations).
Block 62: Classify the collected resources as clean, reusable, and dirty resources.
Block 63: Allocate clean resources to Type 2 and Type 3 mobile stations (e.g., MSp1 and MSp2 stations).
Block 64: Determine if Type 2 and Type 3 mobile stations (e.g., MSp1 and MSp2 stations) meet their data rate requirements? If yes, proceed to block 65, else proceed to block 66.
Block 65: Allocate remaining clean resource to Type 1 mobile stations (e.g., MSp0). End.
Block 66: Determine if the clean resources are exhausted? If yes, process to block 67, else proceed to block 63.
Block 67: Allocate reusable resources to Type 2 and Type 3 mobile stations (e.g., MSp1 and MSp2 stations).
Block 68: Allocate clean resources to co-channel relay cells to compensate their loss.
Block 69: Determine if Type 2 and Type 3 mobile stations (e.g., MSp1 and MSp2 stations) meet their data rate requirements? If not, proceed to block 70, else End.
Block 70: Determine if the reusable resources are exhausted? If yes, proceed to block 71, else proceed to block 67.
Block 71: Collect more reusable resources from remote relay cells. Proceed to block 67.

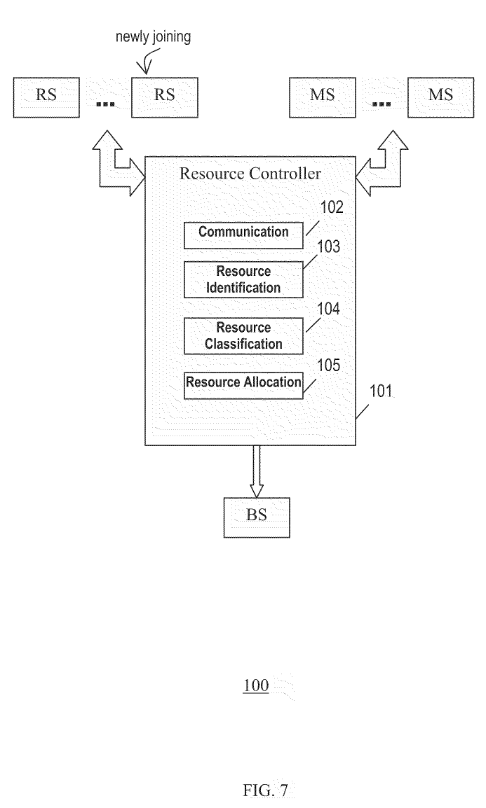

FIG. 7 shows a functional block diagram of a relay enhanced cellular system 100 (such as REC systems in FIGS. 2A-B and 4A), wherein the relay enhanced cellular system 100 includes a resource allocation controller 101, multiple relay stations RS, multiple mobile stations MS and a base station BS. The resource allocation controller 101 is configured for adaptive resource allocation (e.g., subcarrier frequency resource allocation) involving for newly joining relay stations in a relay enhanced cellular system, according to an embodiment of the invention.

The resource controller 101 includes a communication module 102, a resource identification module 103, a resource classification module 104 and a resource allocation module 105. The communication module 102 exchanges information with the RS and MS stations.

The resource controller 101 implements an adaptive resource allocation protocol described above, for adjusting only the resources that can be better utilized by the new RS, and have minimum impact on existing stations (relay cells). As such, the resource identification module 103 is configured to identify resources (e.g., subcarrier frequencies) and the classification module 104 is configured to classify such identified resources, as described above. The resource allocation module 103 is configured to allocate the classified resources optimally to a newly joining relay station, as described above. As such, the resource controller 101 enables simple, prompt, and adaptive resource allocations to newly added relay stations, without engendering significant impact on existing relay cells and on-going traffic. The resource controller 101 may further include a configuration function (not shown) that communicates with the BS, RS and MS stations to configure them according to the resource allocation. The resource controller 101 may further include an optimization function (not shown) that determines link throughput and determines a balancing plan for allocation/reallocation/assignment of resources to the links in the REC system based on the link throughput.

As is known to those skilled in the art, the aforementioned example architectures described above, according to the present invention, can be implemented in many ways, such as program instructions for execution by a processor, as software modules, microcode, as computer program product on computer readable media, as logic circuits, as application specific integrated circuits, as firmware, etc. Further, embodiments of the invention can take the form of an entirely hardware embodiment, an entirely software embodiment or an embodiment containing both hardware and software elements.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information. Computer programs (also called computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor multi-core processor to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Though the present invention has been described with reference to certain versions thereof; however, other versions are possible. Therefore, the spirit and scope of the appended claims should not be limited to the description of the preferred versions contained herein.

What is claimed is:

1. A method of allocating subcarrier frequency resources in a relay enhanced cellular communication system including a base station, multiple relay stations and mobile stations, comprising:
for a new relay station joining the relay enhanced cellular communication system:
identifying mobile stations that the new relay station can service; and
assigning sufficient resources to the new relay station to accommodate minimum data rate requirements of the access links of the identified mobile stations;
wherein said resources are assigned by adjusting existing resource assignments essentially in an optimal manner while reducing impact on existing stations in the relay enhanced cellular communication system.

2. The method of claim 1 wherein identifying mobile stations that the new relay station can service further comprises:
determining local communication channel conditions for the new relay station; and
based on the local channel conditions of the new relay station, identifying a mobile station that may be serviced by the new relay station to accommodate minimum data rate requirements of the access links of the identified mobile station.

3. The method of claim 2 wherein:
identifying mobile stations that may be serviced by the new relay station further comprises:
dividing the mobile stations near the new relay station into multiple types including:
first type: a mobile station outside the coverage of the base station and other relay stations;
second type: mobile station directly served by the base station; and
third type: a mobile station served by adjacent relay stations; and
assigning sufficient resources to the new relay station further comprises:
if the new relay station can more efficiently utilize resources previously assigned to second and third type mobile stations, then adjusting resource assignments such that the resources previously assigned to the second and third type mobile stations are reallocated to the new relay station.

4. The method of claim 3 wherein assigning sufficient resources to the new relay station further comprises:
detecting resources essentially immediately available to the new relay station;
classifying the detected resources into multiple categories based on quality of said resources including:
a clean resource comprising: a residual resource not yet allocated, a resource used by the base station to support second type mobile stations not reusable by other relay stations, and a resource exclusively used by adjacent relay stations to support third type mobile stations not reused by other relay stations;
a reusable resource comprising: a resource used by a remote relay station and reusable by the new relay station; and
a dirty resource comprising: a resource used by an adjacent relay station to support third type mobile stations while the resource is also reused by another adjacent relay station to support non-third type mobile stations, thereby not reusable by the new relay station.

5. The method of claim 4 wherein adjusting existing resource assignments essentially in an optimal manner comprises:
adjusting existing resource assignments based on said resource categories, to provide sufficient resources to the new relay cell to meet minimum data rate requirements of access links of the identified mobile stations while maintaining the resource supplies to other relay cells.

6. The method of claim 5 wherein adjusting existing resource assignments further comprises:
adjusting resources starting from clean resources, by assigning clean resources first to second and third type mobile stations to meet their minimum data rate requirements; and
assigning remaining clean resources to first type mobile stations to meet their minimum data rate requirements.

7. The method of claim 6 wherein adjusting existing resource assignments further comprises:
if clean resources are not sufficient to meet the minimum data rate requirements of the second and third type mobile stations, then reallocating reusable resources that were originally assigned to third type mobile stations to second and third type mobile stations in the new relay cell; and
allocating reusable resources to the new relay cell if reuse improves the overall system throughput, such that if the reallocation of the reusable resources impairs the throughput of the remote relay cells sharing the same resources, clean resources assigned exclusively to second and third type mobile are reused in relay cells impacted by the resource reuse reallocation, wherein clean resources are reused in the relay cells only if the reuse can improve the overall system throughput.

8. The method of claim 7 wherein adjusting existing resource assignments further comprises:
if the reusable resources, together with the clean resources, are still not sufficient to meet the minimum data rate requirements of the second and third type mobile stations, then detecting additional reusable resources from remote relay cells, starting from a remote relay cell that generates the least co-channel interference with the new relay cell;
assigning the additional reusable resources to second and third type mobile stations for the new relay cell until all such mobile stations meet their minimum data rate requirements.

9. A relay enhanced cellular communication system, comprising:
a base station, multiple mobile stations and a relay station;
a resource controller configured for adaptive resource allocation for a new relay station joining the relay enhanced cellular communication system, the resource controller comprising:
a resource identification module configured for identifying mobile stations that the new relay station can service; and
a resource allocation module configured for assigning sufficient resources to the new relay station to accommodate minimum data rate requirements of the access links of the identified mobile stations, wherein said resources are assigned by adjusting existing resource assignments essentially in an optimal manner while reducing impact on existing stations in the relay enhanced cellular communication system.

10. The system of claim 9 wherein the resource identification module is further configured for identifying mobile stations that the new relay station can service by: determining local communication channel conditions for the new relay station; and based on the local channel conditions of the new relay station, identifying mobile stations that may be serviced by the new relay station to accommodate minimum data rate requirements of the access links of the identified mobile stations.

11. The system of claim 10 wherein:
the resource identification module is further configured for identifying mobile stations that may be serviced by the new relay station by dividing the mobile stations near the new relay station into multiple types including:
first type: a mobile station outside the coverage of the base station and other relay stations;
second type: mobile station directly served by the base station; and
third type: a mobile station served by adjacent relay stations; and
the allocation module is further configured for assigning sufficient resources to the new relay station, such that if the new relay station can more efficiently utilize resources previously assigned to second and third type mobile stations, then the allocation module adjusts resource assignments such that the resources previously assigned to the second and third type mobile stations are reallocated to the new relay station.

12. The system of claim 11 wherein the allocation module is further configured for assigning sufficient resources to the new relay station by detecting resources essentially immediately available to the new relay station, the system further including a classification module configured for classifying the detected resources into multiple categories based on quality of said resources including: a clean resource comprising: a residual resource not yet allocated, a resource used by the base station to support second type mobile stations not reusable by other relay stations, and a resource exclusively used by adjacent relay stations to support third type mobile stations not reused by other relay stations; a reusable resource comprising: a resource used by a remote relay station and reusable by the new relay station; and a dirty resource comprising: a resource used by an adjacent relay station to support third type mobile stations while the resource is also reused by another adjacent relay station to support non-third type mobile stations, thereby not reusable by the new relay station.

13. The system of claim 12 wherein the allocation module is further configured for adjusting existing resource assignments essentially in an optimal manner by adjusting existing resource assignments based on said resource categories, to provide sufficient resources to the new relay cell to meet minimum data rate requirements of access links of the identified mobile stations while maintaining the resource supplies to other relay cells.

14. The system of claim 13 wherein the allocation module is further configured for adjusting existing resource assignments by adjusting resources starting from clean resources, by assigning clean resources first to second and third type mobile stations to meet their minimum data rate requirements; and assigning remaining clean resources to first type mobile stations to meet their minimum data rate requirements.

15. The system of claim 14 wherein the allocation module is further configured for adjusting existing resource assignments such that: if clean resources are not sufficient to meet the minimum data rate requirements of the second and third type mobile stations, then the allocation module reallocates reusable resources that were originally assigned to third type mobile stations to second and third type mobile stations in the new relay cell; and the allocation module allocates reusable resources to the new relay cell if reuse improves the overall system throughput, such that if the reallocation of the reusable resources impairs the throughput of the remote relay cells sharing the same resources, clean resources assigned exclusively to second and third type mobile are reused in relay cells impacted by the resource reuse reallocation, wherein clean resources are reused in the relay cells only if the reuse can improve the overall system throughput.

16. The system of claim 15 wherein the allocation module is further configured for adjusting existing resource assignments such that: if the reusable resources, together with the clean resources, are still not sufficient to meet the minimum data rate requirements of the second and third type mobile stations, then the allocation module detects additional reusable resources from remote relay cells, starting from a remote relay cell that generates the least co-channel interference with the new relay cell; and the allocation modules assigns the additional reusable resources to second and third type mobile stations for the new relay cell until all such mobile stations meet their minimum data rate requirements.

17. A computer program product for adaptive resource allocation for a new relay station joining a relay enhanced cellular communication system, the computer program product comprising:
a computer usable medium having computer readable program code embodied therewith, wherein the computer readable program when executed on the computer causes the computer to:
for a new relay station joining the relay enhanced cellular communication system:
identify mobile stations that the new relay station can service; and
assign sufficient resources to the new relay station to accommodate minimum data rate requirements of the access links of the identified mobile stations;
wherein said resources are assigned by adjusting existing resource assignments essentially in an optimal manner while reducing impact on existing stations in the relay enhanced cellular communication system.

18. The computer program product of claim 17 further comprising computer readable program code for identifying a mobile station that the new relay station can service further comprises by:
determining local communication channel conditions for the new relay station; and
based on the local channel conditions of the new relay station, identifying a mobile station that may be serviced by the new relay station to accommodate minimum data rate requirements of the access links of the identified mobile station.

19. The computer program product of claim 18 further comprising computer readable program code for:
identifying mobile stations that may be serviced by the new relay station by:
dividing the mobile stations near the new relay station into multiple types including:
first type: a mobile station outside the coverage of the base station and other relay stations;
second type: mobile station directly served by the base station; and
third type: a mobile station served by adjacent relay stations; and
assigning sufficient resources to the new relay station by:
if the new relay station can more efficiently utilize resources previously assigned to second and third type mobile stations, then adjusting resource assignments such that the resources previously assigned to the second and third type mobile stations are reallocated to the new relay station.

20. The computer program product of claim 19 further comprising computer readable program code for assigning sufficient resources to the new relay station by:
detecting resources essentially immediately available to the new relay station;
classifying the detected resources into multiple categories based on quality of said resources including:
a clean resource comprising: a residual resource not yet allocated, a resource used by the base station to support second type mobile stations not reusable by other relay stations, and a resource exclusively used by adjacent relay stations to support third type mobile stations not reused by other relay stations;
a reusable resource comprising: a resource used by a remote relay station and reusable by the new relay station; and
a dirty resource comprising: a resource used by an adjacent relay station to support third type mobile stations while the resource is also reused by another adjacent relay station to support non-third type mobile stations, thereby not reusable by the new relay station.

21. The computer program product of claim 20 further comprising computer readable program code for adjusting existing resource assignments essentially in an optimal manner by:
adjusting existing resource assignments based on said resource categories, to provide sufficient resources to the new relay cell to meet minimum data rate requirements of access links of the identified mobile stations while maintaining the resource supplies to other relay cells.

22. The computer program product of claim 21 further comprising computer readable program code for adjusting existing resource assignments further by:
adjusting resources starting from clean resources, by assigning clean resources first to second and third type mobile stations to meet their minimum data rate requirements;
assigning remaining clean resources to first type mobile stations to meet their minimum data rate requirements.

23. The computer program product of claim 22 further comprising computer readable program code for adjusting existing resource assignments further by:
if clean resources are not sufficient to meet the minimum data rate requirements of the second and third type mobile stations, then reallocating reusable resources that were originally assigned to third type mobile stations to second and third type mobile stations in the new relay cell;
allocating reusable resources to the new relay cell if reuse improves the overall system throughput, such that if the reallocation of the reusable resources impairs the throughput of the remote relay cells sharing the same resources, clean resources assigned exclusively to second and third type mobile are reused in relay cells impacted by the resource reuse reallocation, wherein clean resources are reused in the relay cells only if the reuse can improve the overall system throughput.

24. The computer program product of claim 23 further comprising computer readable program code for adjusting existing resource assignments by:
if the reusable resources, together with the clean resources, are still not sufficient to meet the minimum data rate requirements of the second and third type mobile stations, then detecting additional reusable resources from remote relay cells, starting from a remote relay cell that generates the least co-channel interference with the new relay cell;
assigning the additional reusable resources to second and third type mobile stations for the new relay cell until all such mobile stations meet their minimum data rate requirements.
